(19) United States
(12) Patent Application Publication
(10) Pub. No.: US 2023/0186828 A1
(43) Pub. Date: Jun. 15, 2023

(54) DISPLAY DEVICE AND METHOD FOR DRIVING DISPLAY DEVICE

(71) Applicant: Samsung Display Co., Ltd., Yongin-si (KR)

(72) Inventor: JUNGYU LEE, Seoul (KR)

(21) Appl. No.: 18/074,984

(22) Filed: Dec. 5, 2022

(30) Foreign Application Priority Data
Dec. 13, 2021 (KR) 10-2021-0177408

(51) Int. Cl. G09G 3/20; G09G 3/3208; G06N 20/00

(52) U.S. Cl. CPC G09G 3/2096; G06N 20/00; G09G 3/3208; G09G 2320/0686; H04N 19/65

(57) ABSTRACT

A display device includes a display panel which displays an image, and a panel driving block which receives an image signal from an outside and to drive the display panel. The panel driving block includes a corrected image generator including a correcting algorithm trained in a machine learning scheme, where the corrected image generator corrects the image signal to a corrected image signal through the correcting algorithm.

This application claims priority to Korean Patent Application No. 10-2021-0177408, filed on Dec. 13, 2021, and all the benefits accruing therefrom under 35 U.S.C. §119, the content of which in its entirety is herein incorporated by reference.

### BACKGROUND

### 1. Field

Embodiments of the disclosure disclosed herein relate to a display device and a method for driving the display device, and more particularly, relate to a display device, capable of correcting an image displayed on a display panel, and a method for driving the display device.

### 2. Description of the Related Art

Various types of display device have been used to provide image information. In particular, the display device has employed an organic light emitting display (OLED) device, an inorganic light emitting display device, a quantum dot display device, or a liquid crystal display (LCD) device, for example.

The display device may include a display panel to display an image and a panel driving block coupled to the display panel to apply a driving signal to the display panel. The display panel may include pixels to emit light. In a case where the display device is an OLED device, the display panel may include an organic light emitting diode to generate light.

### SUMMARY

Embodiments of the disclosure provide a display device for providing an image, which has excellent display quality, to a user by correcting the image displayed on the display panel through a correcting algorithm which is trained in a machine learning scheme.

According to an embodiment, a display device includes a display panel which displays an image, and a panel driving block which receives an image signal from the outside and to drive the display panel. In such an embodiment, the panel driving block includes a corrected image generator including a correcting algorithm trained in a machine learning scheme, where the corrected image generator corrects the image signal to a corrected image signal through the correcting algorithm.

According to an embodiment of the disclosure, the correcting algorithm may be trained based on a generative adversarial network (GAN) model.

According to an embodiment of the disclosure, the corrected image generator may receive first learning data including a weight of the correcting algorithm, which is produced in a process of training the correcting algorithm based on the GAN model. In such an embodiment, the corrected image generator may generate the corrected image signal by correcting the image signal based on the correcting algorithm and the first learning data.

According to the disclosure, the correcting algorithm may be trained based on a variational auto encoder (VAE) model.

According to an embodiment of the disclosure, the corrected image generator may receive second learning data including a weight of the correcting algorithm, which is produced in a process of training the correcting algorithm based on the VAE model. In such an embodiment, the corrected image generator may generate the corrected image signal by correcting the image signal based on the correcting algorithm and the second learning data.

According to an embodiment of the disclosure, the display panel includes a correcting area of the image in which a correcting image is displayed, where the correcting image includes a logo image and a logo surrounding image corresponding to a surrounding of the logo image. In such an embodiment, the corrected image generator may correct a partial image signal, which corresponds to the correcting area, of the image signal to the corrected image signal.

According to an embodiment of the disclosure, the correcting area includes a logo area in which the logo image is displayed and a logo surrounding area in which the logo surrounding image is displayed. In such an embodiment, the partial image signal may include a logo area signal for the logo image, and the corrected image generator may generate the corrected image signal by correcting the logo area signal.

According to an embodiment of the disclosure, the logo surrounding image may include a first logo surrounding image and a second logo surrounding image. In such an embodiment, the logo surrounding area may include a first logo surrounding area in which the first logo surrounding image is displayed, and a second logo surrounding area in which the second logo surrounding image is displayed, where the second logo surrounding area is interposed between the logo area and the first logo surrounding area. In such an embodiment, the partial image signal may further include a surrounding area signal for the second logo surrounding image, and the corrected image generator may generate the corrected image signal by correcting the logo area signal and the surrounding area signal.

According to an embodiment of the disclosure, the corrected image generator may generate the corrected image signal in a way such that luminance of the logo area signal is decreased and the luminance of the surrounding area signal is increased.

According to an embodiment of the disclosure, the panel driving block may further include an extractor which extracts the partial image signal from the image signal. In such an embodiment, the corrected image generator may receive the partial image signal from the extractor, and generate the corrected image signal by correcting the partial image signal.

According to an embodiment of the disclosure, the panel driving block may include a controller which generates image data based on the image signal, and a source driver which receives the image data from the controller, generates based on the image data and transmits a data signal for displaying the image on the display panel. In such an embodiment, the extractor and the corrected image generator may be included in the controller.

According to an embodiment of the disclosure, the controller may further include a data converter which receives the image signal and the corrected image signal, and generates the image data, based on the image signal and the corrected image signal.

According to an embodiment of the disclosure, a method for driving a display device includes receiving an image signal from an outside, and generating a corrected image signal by correcting the image signal by a corrected image generator of the display device, where the corrected image generator includes a correcting algorithm trained in a machine learning scheme. In such an embodiment, the method for driving the display device further includes displaying an image on a display panel, based on the corrected image signal.

According to an embodiment of the disclosure, the method for driving the display device may further include training the correcting algorithm in the machine learning scheme.

According to an embodiment of the disclosure, the correcting algorithm may be trained based on a GAN model.

According to an embodiment of the disclosure, the training the correcting algorithm includes generating a correction-training image signal by applying a training image signal to a preliminarily-corrected image generator, and applying the correction-training image signal and a comparing image signal to a determining device, and allowing the determining device to generate a determining signal by comparing the correction-training image signal with the comparing image signal. In such an embodiment, the training of the correcting algorithm may include training at least one selected from the preliminarily-corrected image generator and the determining device, by comparing the determining signal with a reference value.

According to an embodiment of the disclosure, the correcting algorithm may be trained based on a VAE model.

According to an embodiment of the disclosure, the training the correcting algorithm may include applying a training image signal and a comparing image signal to an encoder of a preliminarily-corrected image generator, and generating a correction-encoded signal by encoding the training image signal. In such an embodiment, the training the correcting algorithm may further include generating a correction-training image signal by decoding a sampled correction-encoded signal through a decoder of the preliminarily-corrected image generator, and training at least one selected from the encoder and the decoder, by comparing the comparing image signal with the correction-training image signal.

According to an embodiment of the disclosure, the display panel may include a correcting area, in which a correcting image is displayed, where the correcting image includes a logo image and a logo surrounding image corresponding to a surrounding of the logo image, of the image. In such an embodiment, the generating the corrected image signal may include extracting a partial image signal corresponding to the correcting area from the image signal, and generating, by the corrected image generator, the corrected image signal by correcting the partial image signal.

According to an embodiment of the disclosure, the logo surrounding image may include a first logo surrounding image and a second logo surrounding image. In such an embodiment, the correcting area may include a logo area in which the logo image is displayed, a first logo surrounding area in which the first logo surrounding image is displayed, and a second logo surrounding area in which the second logo surrounding image is displayed, where the second logo surrounding area is interposed between the logo area and the first logo surrounding area. In such an embodiment, the partial image signal may include a logo area signal for the logo image and a surrounding area signal for the second logo surrounding image. In such an embodiment, the generating the corrected image signal may include generating, by the corrected image generator, the corrected image signal in a way such that luminance of the logo area signal is decreased and luminance of the surrounding area signal is increased.

### BRIEF DESCRIPTION OF THE DRAWINGS

The above and other features of the disclosure will become apparent by describing in detail embodiments thereof with reference to the accompanying drawings, in which:

FIG. 1 is a perspective view of a display device, according to an embodiment of the disclosure;

FIG. 2 is an exploded perspective view of a display device, according to an embodiment of the disclosure;

FIG. 3 is a block diagram of a display device, according to an embodiment of the disclosure;

FIG. 4 is a block diagram illustrating a structure of a controller, according to an embodiment of the disclosure;

FIGS. 5A and 5B are plan views illustrating a correcting area included in a display panel, according to an embodiment of the disclosure;

FIG. 6 is a block diagram illustrating the structure and the operation of a controller, when a correcting algorithm trained is to prevent an afterimage.

FIG. 7 is a block diagram illustrating the process of training a correcting algorithm, according to an embodiment of the disclosure;

FIGS. 8A to 9B are graphs illustrating a correcting algorithm trained, according to an embodiment of the disclosure;

FIG. 10 is a block diagram illustrating the structure and the operation of a controller, when the correcting algorithm trained is to prevent an afterimage;

FIG. 11 is a block diagram illustrating the process of training a correcting algorithm, according to an embodiment of the disclosure;

FIG. 12 is a flowchart illustrating a method for driving a display device, according to an embodiment of the disclosure;

FIGS. 13 and 14 are flowcharts illustrating a method for training a correcting algorithm in a machine learning scheme, according to an embodiment of the disclosure; and

FIG. 15 is a flowchart illustrating a method for generating a corrected image signal to prevent an afterimage through a correcting algorithm trained, according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

In the specification, the expression that a first component (or area, layer, part, portion, etc.) is “on”, “connected with”, or “coupled to” a second component means that the first component is directly on, connected with, or coupled to the second component or means that a third component is disposed therebetween.

The same reference numeral refers to the same component. In addition, in drawings, thicknesses, proportions, and dimensions of components may be exaggerated to describe the technical features effectively. “Or” means “and/or.” The term “and/or” includes any and all combinations of one or more of the associated listed items.

Although the terms “first”, “second”, etc. may be used to describe various components, the components should not be construed as being limited by the terms. The terms are only used to distinguish one component from another component. For example, without departing from the scope and spirit of the disclosure, a first component may be referred to as a second component, and similarly, the second component may be referred to as the first component.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.”

In addition, the terms “under”, “below”, “on”, “above”, etc. are used to describe the correlation of components illustrated in drawings. The terms that are relative in concept are described based on a direction shown in drawings.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, or components or a combination thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ± 30%, 20%, 10% or 5% of the stated value.

Unless otherwise defined, all terms (including technical terms and scientific terms) used in the specification have the same meaning as commonly understood by one skilled in the art to which the disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

Embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present disclosure.

Hereinafter, embodiments of the disclosure will be described with reference to accompanying drawings.

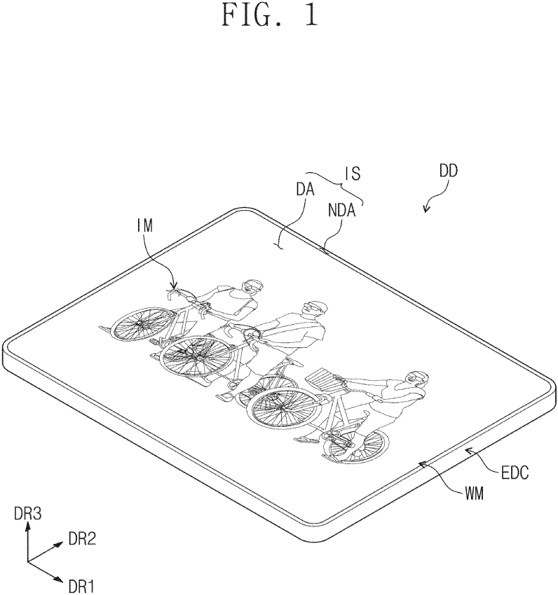

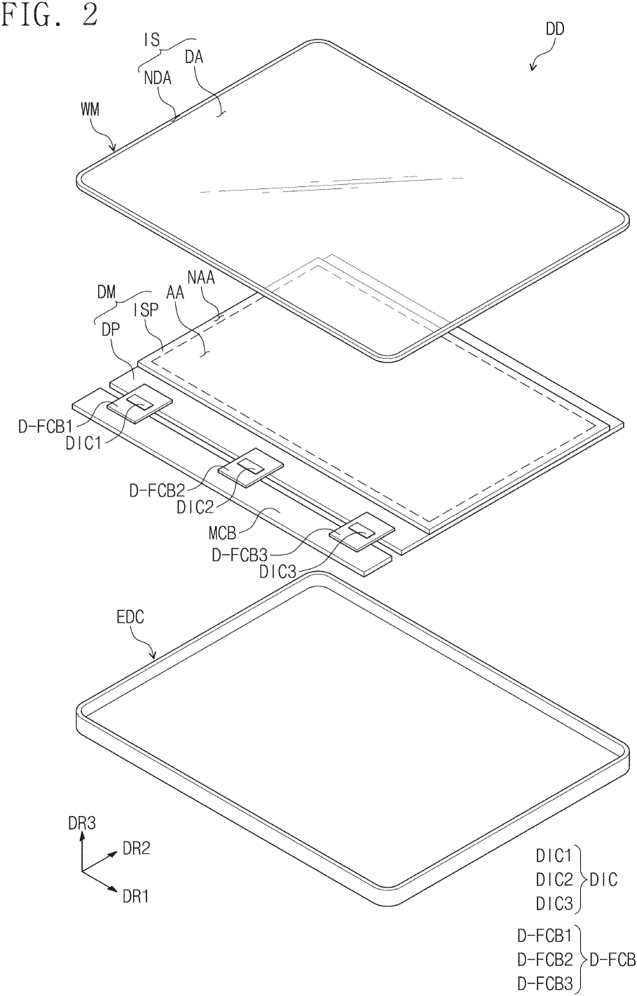

FIG. 1 is a perspective view of a display device, according to an embodiment of the disclosure, and FIG. 2 is an exploded perspective view of a display device, according to an embodiment of the disclosure.

Referring to FIGS. 1 and 2, an embodiment of a display device DD is a device activated in response to an electrical signal. According to an embodiment of the disclosure, the display device DD may include a small or medium-size display device, such as a cellular phone, a tablet, a laptop computer, a vehicle navigation, or a game console in addition to a large-size display device, such as a television or a monitor, for example, but not being limited thereto. Alternatively, the display device DD may be applied to any other display device(s) without departing from the concept of the disclosure.

In an embodiment, the display device DD has a rectangular shape having a longer side in a first direction DR1, and a shorter side in a second direction DR2 crossing the first direction DR1. However, the shape of the display device DD is not limited thereto, and various display devices DD having various shapes may be provided. The display device DD may display an image IM, in a third direction DR3, on a display surface IS parallel to the first direction DR1 and the second direction DR2. The display surface IS to display the image IM may correspond to a front surface of the display device DD.

According to an embodiment, a front surface (or top surface) and a rear surface (or a bottom surface) of each of members are defined based on a direction that the image IM is displayed. The front surface and the rear surface are opposite to each other in the third direction DR3, and a normal direction to the front surface and the rear surface may parallel to the third direction DR3.

Here, the third direction DR3 may be a thickness direction of the display device DD. The distance between the front surface and the rear surface in the third direction DR3 may correspond to the thickness of the display device DD in the third direction DR3. Herein, the first direction DR1, the second direction DR2, and the third direction DR3 may be relative concepts and may be changed to different directions.

In an embodiment, the display device DD may sense an external input applied from the outside. The external input may include various types of inputs that provided from the outside of the display device DD. According to an embodiment of the disclosure, the display device DD may sense an external input of the user, which is applied from the outside. The external input by the user may include any one of various external inputs, such as a part of a body of the user, light, heat, a gaze, or pressure, or the combination thereof. In such an embodiment, the display device DD may sense the external input of the user, which is applied to the side surface or the rear surface of the display device DD depending on the structures of the display device DD, and is not limited to any one embodiment. For example, according to an embodiment, the external input may include an input made by an input device (e.g., a stylus pen, an active pen, a touch pen, an electronic pen, or an e-pen).

The display surface IS of the display device DD may be divided into a display area DA and a non-display area NDA. The display area DA may be an area to display an image IM. The user views the image through the display area DA. According to an embodiment of the embodiment, the display area DA is illustrated as a rectangular shape rounded in vertexes. However, the shape is provided for the illustrative purpose. In an alternative embodiment, for example, the display area DA may have various shapes, and not limited to any one embodiment.

The non-display area NDA is adjacent to the display area DA. The non-display area NDA may have a specific color. The non-display area NDA may surround the display area DA. The shape of the display area DA may actually be defined by the non-display area NDA. However, the above shape of the display area DA is provided for the illustrative purpose. In an alternative embodiment, for example, the non-display area NDA may be disposed to be adjacent to only one side of the display area DA or may be omitted. According to an embodiment of the disclosure, the display device DD may include various embodiments, and is not limited to any one embodiment.

In an embodiment, as illustrated in FIG. 2, the display device DD may include a display module DM and a window WM disposed on the display module DM. The display module DM includes a display panel DP and an input sensing layer ISP.

According to an embodiment of the disclosure, the display panel DP may include an emissive-type display panel. In an embodiment, for example, the display panel DP may be an organic light emitting display panel, an inorganic light emitting display panel, or a quantum dot light emitting display panel. A light emitting layer of the organic light emitting display panel may include an organic light emitting material. A light emitting layer of the inorganic light emitting display panel may include an inorganic light emitting material. A light emitting layer of the quantum dot light emitting display panel may include a quantum dot and/or a quantum rod. Hereinafter, for convenience of description, embodiments where the display panel DP is an organic light emitting display panel will be described in detail.

The display panel DP may output the image IM, and the output image IM may be displayed through the display surface IS.

The input sensing layer ISP may be disposed on the display panel DP to sense the external input. In an embodiment, the input sensing layer ISP may be directly disposed on the display panel DP. In such an embodiment of the disclosure, the input sensing layer ISP may be formed on the display panel DP through a subsequent process. In such an embodiment, when the input sensing layer ISP is directly disposed on the display panel DP, an inner adhesive film (not illustrated) is not interposed between the input sensing layer ISP and the display panel DP. In an alternative embodiment, the inner adhesive film may be interposed between the input sensing layer ISP and the display panel DP. In such an embodiment, the input sensing layer ISP is not fabricated together with the display panel DP through the subsequent processes. In such an embodiment, after fabricating the input sensing layer ISP through a process separated from that of the display panel DP, the input sensing layer ISP may be fixed on a top surface of the display panel DP through the inner adhesive film.

The window WM may include a transparent material to output the image IM. In an embodiment, for example, the window WM may include glass, sapphire, or plastic. Although the window WM is illustrated in a single layer, the disclosure is not limited thereto. In an embodiment, for example, the window WM may include a plurality of layers.

In an embodiment, although not illustrated, the non-display area NDA of the display device DD may be actually provided by printing one area of the window WM with a material including a specific color. According to an embodiment of the disclosure, the window WM may include a light shielding pattern for defining the non-display area NDA. The light shielding pattern, which has the form of an organic film having a color, may be, for example, formed in a coating manner.

The window WM may be coupled to the display module DM through an adhesive film. According to an embodiment of the disclosure, the adhesive film may include an optically clear adhesive film (OCA). However, the adhesive film is not limited thereto, but may include a typical adhesive agent and/or adhesion agent. In an alternative embodiment, for example, the adhesive film may include optically clear resin (OCR), or a pressure sensitive adhesive film (PSA).

An anti-reflective layer may be further interposed between the window WM and the display module DM. The anti-reflective layer reduces a reflective index of external light incident from an upper portion of the window WM. According to an embodiment of the disclosure, the anti-reflective layer may include a phase retarder and a polarizer. The phase retarder may be provided in a film or liquid crystal coating form and may include a λ/2 phase retarder and/or a λ/4 phase retarder. The polarizer may be provided in a film type or a liquid crystal coating type. The film-type polarizer may include a stretched synthetic resin film, and the liquid crystal coating-type polarizer may include liquid crystals aligned in a predetermined array. The phase retarder and the polarizer may be implemented with or define as a single polarization film.

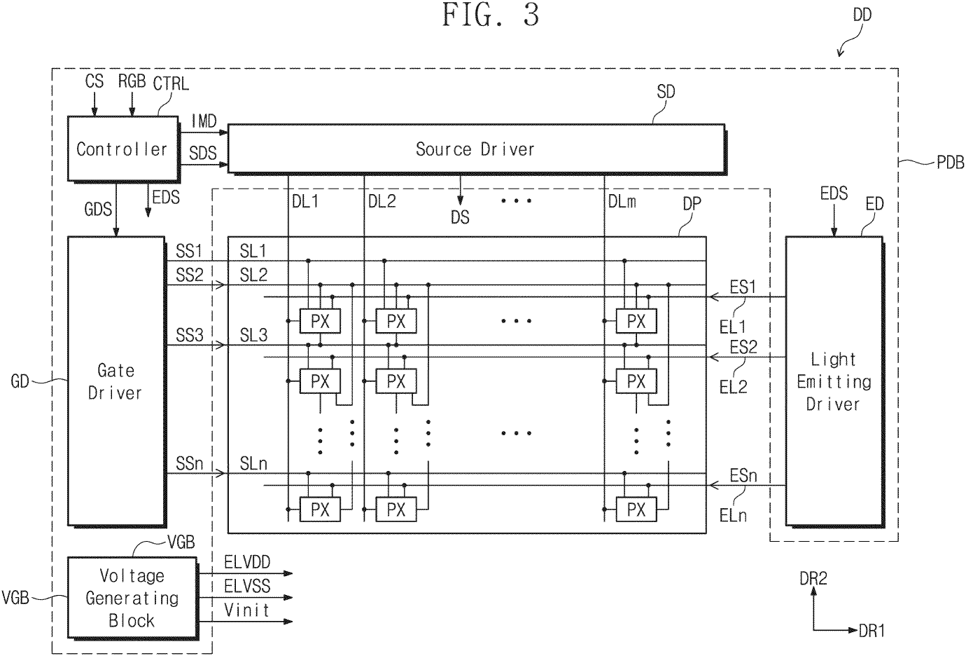

According to an embodiment of the disclosure, the anti-reflective layer may include color filters. The arrangement of the color filters may be determined based on colors of light generated from a plurality of pixels PX (see FIG. 3) included in the display panel DP. The anti-reflective layer may further include a light shielding pattern.

The display module DM may display the image IM, and may transmit/receive information on the external input, in response to an electrical signal. The display module DM may be defined with an active area AA and a non-active area NAA. The active area AA may be defined as an area to output the image IM provided in the display module DM. In an embodiment, the active area AA may be defined as an area in which the input sensing layer ISP senses the external input applied from the outside.

The non-active area NAA may be adjacent to the active area AA. In an embodiment, for example, the non-active area NAA may surround the active area AA. However, the above form is provided for the illustrative purpose. In such an embodiment, the non-active area NAA may have various forms, and is not limited to any one embodiment. According to an embodiment, the active area AA of the display module DM may correspond to at least a portion of the display area DA.

The display module DM may further include a main circuit board MCB, a plurality of flexible circuit films D-FCB, and a plurality of driving chips DIC. The main circuit board MCB may be connected with the flexible circuit films D-FCB and electrically connected with the display panel DP. The flexible circuit films D-FCB are connected with the display panel DP to electrically connect the display panel DP with the main circuit board MCB. The main circuit board MCB may include a plurality of driving devices. The plurality of driving devices may include a circuit part to drive the display panel DP. The driving chips DIC may be mounted on the flexible circuit films D-FCB.

According to an embodiment of the disclosure, the flexible circuit films D-FCB may include a first flexible circuit film D-FCB1, a second flexible circuit film D-FCB2, and a third flexible circuit film D-FCB3. The driving chips DIC may include a first driving chip DIC1, a second driving chip DIC2, and a third driving chip DIC3. The first to third flexible circuit films D-FCB1, D-FCB2, and D-FCB3 are disposed to be spaced apart from each other in the first direction DR1, and connected with the display panel DP to electrically connect the display panel DP with the main circuit board MCB. The first driving chip DIC1 may be mounted on the first flexible circuit film D-FCB1. The second driving chip DIC2 may be mounted on the second flexible circuit film D-FCB2. The third driving chip DIC3 may be mounted on the third flexible circuit film D-FCB3. However, the disclosure is not limited thereto. In an alternative embodiment, for example, the display panel DP may be electrically connected with the main circuit board MCB through a single (or same) flexible circuit film, and only a single driving chip may be mounted on the single flexible circuit film. In an embodiment, the display panel DP may be electrically connected with the main circuit board MCB through at least four flexible circuit films, and driving chips may be mounted on the flexible circuit films, respectively.

Although FIG. 2 illustrates an embodiment where the first to third driving chips DIC1, DIC2, and DIC3 are mounted on the first to third flexible circuit films D-FCB1, D-FCB2, and D-FCB3, respectively, the disclosure is not limited thereto. In an alternative embodiment, for example, the first to third driving chips DIC1, DIC2, and DIC3 may be directly mounted on the display panel DP. In such an embodiment, a part, on which the driving chips DIC1, DIC2, and DIC3 are mounted, of the display panel DP may be bent and disposed on a rear surface of the display module DM. In an embodiment, for example, the first to third driving chips DIC1, DIC2, and DIC3 may be directly mounted on the main circuit board MCB.

The input sensing layer ISP may be electrically connected to the main circuit board MCB through the flexible circuit films D-FCB. However, the disclosure is not limited thereto. In an alternative embodiment, the display module DM may additionally include a separate flexible circuit film to electrically connect the input sensing layer ISP to the main circuit board MCB.

The display device DD may further include an external case EDC to receive the display module DM. The external case EDC may be coupled to the window WM to define the outer appearance of the display device DD. The external case EDC may absorb the impact applied from the outside and may prevent a foreign material/moisture from being infiltrated into the display module DM to protect components received in the external case EDC. According to an embodiment, the external case EDC may be provided in the form where a plurality of receiving members are assembled.

According to an embodiment, the display device DD may further include an electronic module including various functional modules to operate the display module DM, a power supply module to supply power for the overall operation of the display device DD, and a bracket coupled to the display module DM and/or the external case EDC to partition the internal space of the display device DD.

FIG. 3 is a block diagram illustrating a display device, according to an embodiment of the disclosure.

Referring to FIG. 3, the display device DD includes the display panel DP and a panel driving block PDB. The panel driving block PDB controls the driving of the display panel DP.

According to an embodiment of the disclosure, the panel driving block PDB includes a controller CTRL, a source driver SD, a gate driver GD, a voltage generating block VGB, and a light emitting driver ED.

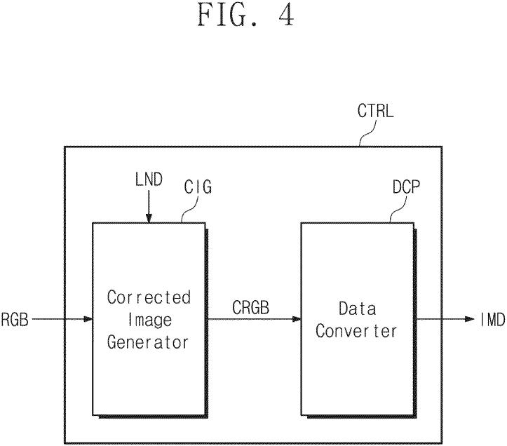

The controller CTRL receives an image signal RGB and an external control signal CS. The controller CTRL generates a corrected image signal CRGB (see FIG. 4) by correcting the image signal RGB. A configuration and an operation of the controller CTRL to generate the corrected image signal CRGB by correcting the image signal RGB will be described below with reference to FIG. 4 to 9B. The controller CTRL may transform a data format of the corrected image signal CRGB to generate image data IMD to be matched with the specification of an interface with the source driver SD. According to an embodiment of the disclosure, the controller CTRL may transform data formats of the image signal RGB and the corrected image signal CRGB to generate image data IMD to be matched with the specification of the interface with the source driver SD. The controller CTRL generates a source driving signal SDS, a gate driving signal GDS, and a light emitting control signal EDS, based on the external control signal CS. The external control signal CS may include a vertical synchronization signal, a horizontal synchronization signal, and a main clock signal.

The controller CTRL transmits the image data IMD and the source driving signal SDS to the source driver SD. The source driving signal SDS may include a horizontal start signal to commence the operation of the source driver SD. The source driver SD generates a data signal DS based on the image data IMD, in response to the source driving signal SDS. The source driver SD outputs the data signal DS to a plurality of data lines DL1 to DLm to be described later. The data signal DS may refer to an analog voltage corresponding to a grayscale value of the image data IMD.

The controller CTRL transmits the gate driving signal GDS to the gate driver GD. The gate driving signal GDS may include a vertical start signal for commencing an operation of the gate driver GD, and a scan clock signal for determining an output timing of scan signals SS1 to SSn. The gate driver GD generates the scan signals SS1 to SSn based on the gate driving signal GDS. The gate driver GD outputs the scan signals SS1 to SSn to a plurality of scan lines SL1 to SLn to be described later.

The controller CTRL transmits the light emitting control signal EDS to the light emitting driver ED. The light emitting driver ED outputs light emitting control signals ES1 to ESn to a plurality of light emitting lines EL1 to ELn in response to the light emitting control signal EDS.

The voltage generating block VGB generates voltages used for the operation of the display panel DP. According to an embodiment of the disclosure, the voltage generating block VGB generates a first driving voltage ELVDD, a second driving voltage ELVSS, and an initialization voltage Vinit. According to an embodiment of the disclosure, the voltage generating block VGB may operate depending on the control of the controller CTRL. According to an embodiment of the disclosure, the voltage level of the first driving voltage ELVDD is greater than the voltage level of the second driving voltage ELVSS. In an embodiment, for example, the voltage level of the first driving voltage ELVDD may be in a range of about 20 volts (V) to about 30 V. The voltage level of the initialization voltage Vinit is lower than the voltage level of the second driving voltage ELVSS. According to an embodiment of the disclosure, the voltage level of the initialization voltage Vinit may be in a range of about 1 V to about 9 V.

According to an embodiment of the disclosure, the display panel DP includes the plurality of scan lines SL1 to SLn, the plurality of data lines DL1 to DLm, the plurality of light emitting lines EL1 to ELn, and the plurality of pixels PX.

The scan lines SL1 to SLn extend from the gate driver GD in the first direction DR1 and are arranged to be spaced from each other in the second direction DR2. The data lines DL1 to DLm extend from the source driver SD in a direction opposite to the second direction DR2 and are arranged to be spaced from each other in the first direction DR1.

In an embodiment, each of the pixels PX is electrically connected to three relevant (or corresponding) scan lines among the scan lines SL1 to SLn. In such an embodiment, each of the pixels PX is electrically connected to one relevant light emitting line of the light emitting lines EL1 to ELn and one relevant data line of the data lines DL1 to DLm. In an embodiment, for example, as illustrated in FIG. 3, a first pixel in a first row may be connected to the first to third scan lines SL1, SL2, and SL3, the first light emitting line EL1, and the first data line DL1. However, according to an embodiment of the disclosure, a connection relationship among the pixels PX and the scan lines SL1 to SLn, the data lines DL1 to DLm, and the light emitting lines EL1 to ELn may be variously modified based on a configuration of a driver circuit of the pixels PX.

Each pixel PX may include a light emitting diode to produce color light. In an embodiment, for example, the pixels PX may include red pixels to emit red color light, green pixels to emit green color light, and blue pixels to emit blue color light. A light emitting diode of a red pixel, a light emitting diode of a green pixel, and a light emitting diode of a blue pixel may include light emitting layers including different materials from each other. According to an embodiment of the disclosure, each of the pixels PX may include white pixels to emit white color light. In such an embodiment, the anti-reflective layer included in the display device DD may further include color filters. The display device DD may display the image IM based on lights output after the white color light passes through the color filters. In an alternative embodiment of the disclosure, the pixels PX may include blue pixels to emit the blue color light. In such an embodiment, the display device DD may display the image IM based on light output after the blue color light passes through color filters. According to an embodiment of the disclosure, when the blue color light passes through the color filters, the light passed therethrough may have a color having a wavelength different from that of the blue color light. According to an embodiment of the disclosure, each of the color filters may include a quantum dot. The quantum dot is a particle to adjust the wavelength of light emitted by converting the wavelength of incident light. The quantum dot may adjust the wavelength of light emitted depending on a particle size. Accordingly, the quantum dot may emit the red color light, the green color light, or the blue color light.

Each of the pixels PX includes a pixel circuit part to control a light emission operation of the light emitting diode. The pixel circuit part may include a plurality of transistors and a capacitor. Each of the pixels PX receives the first driving voltage ELVDD, the second driving voltage ELVSS, and the initialization voltage Vinit.

FIG. 4 is a block diagram illustrating a structure of a controller according to an embodiment of the disclosure.

Referring to FIG. 4, in an embodiment, the controller CTRL includes a corrected image generator CIG and a data converter DCP. The corrected image generator CIG may include a correcting algorithm trained in a machine learning scheme. The corrected image generator CIG may receive the image signal RGB from the outside, and may correct the image signal RGB to the corrected image signal CRGB through the correcting algorithm.

A machine learning algorithm, which constitutes one field of artificial intelligence, is an algorithm to implement artificial intelligence (AI) through software. In detail, the machine learning algorithm is an algorithm to allow a processor of a computer to learn data, to automatically find out a pattern, and to perform an appropriate task. The machine learning algorithm is mainly classified into a supervised learning algorithm, an unsupervised learning algorithm, and a reinforcement learning algorithm. In an embodiment, the correcting algorithm may be trained based on the unsupervised learning algorithm to learn the feature of given learning data and automatically learn a pattern of the learning data. In an embodiment, the correcting algorithm may be trained using a generative model to estimate the probability distribution of the learning data, and to generate pseudo data following the probability distribution of the learning data, by performing learning based on the learning data. According to an embodiment of the disclosure, the correcting algorithm may be trained through a generative adversarial network (GAN) model or a variational auto encoder (VAE) model of generative models.

According to an embodiment of the disclosure, the corrected image generator CIG may additionally receive learning data LND obtained in the process of training the correcting algorithm in the machine learning scheme. According to an embodiment of the disclosure, the learning data LND may include a weight of the correcting algorithm for each image signal RGB. The corrected image generator CIG may generate the corrected image signal CRGB by changing the weight of the correcting algorithm depending on the image signal RGB, based on the learning data LND.

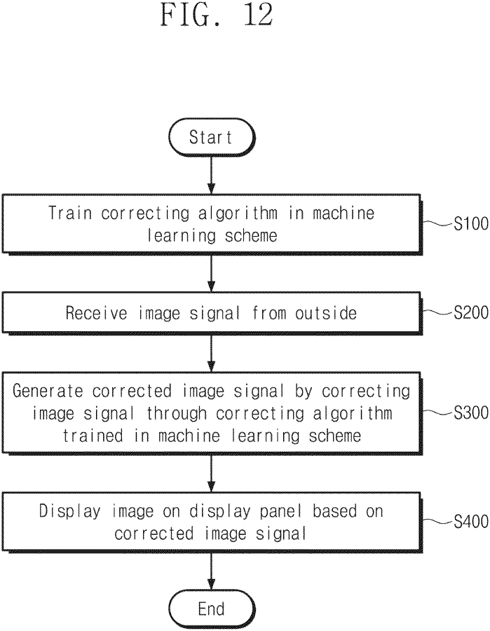

According to an embodiment of the disclosure, the correcting algorithm may be trained based on a target algorithm. In an embodiment, the probability distribution of the corrected image signal CRGB generated through the correcting algorithm may be similar to the probability distribution of a comparing image signal CPS (see FIG. 7) generated through the target algorithm. The training of the correcting algorithm in the machine learning scheme will be described in detail below with reference to FIGS. 7 and 11.

The data converter DCP receives the corrected image signal CRGB from the corrected image generator CIG. The data converter DCP generates the image data IMD based on the corrected image signal CRGB.

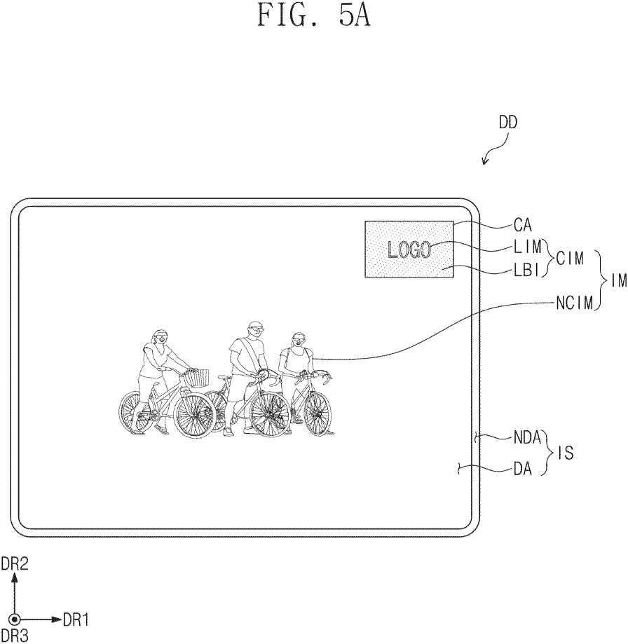

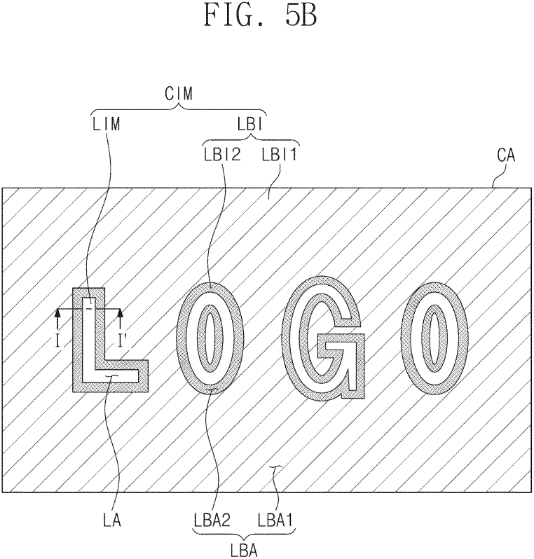

FIGS. 5A and 5B are plan views illustrating a correcting area included in a display panel, according to an embodiment of the disclosure. Hereinafter, components and signals, which are the same as the components and signals described with reference to FIG. 1, will be assigned with the same reference numerals and any repetitive detailed description thereof will be omitted to avoid redundancy.

Referring to FIGS. 5A and 5B, in an embodiment, the image IM displayed on the display panel DP may include a correcting image CIM and a non-correcting image NCIM. The correcting image CIM may include a logo image LIM and a logo surrounding image LBI. According to an embodiment of the disclosure, the display area DA may include a correcting area CA for displaying the correcting image CIM.

The logo image LIM may be an image displayed at a fixed position with a specific grayscale for a specific time. In an embodiment, for example, the logo image LIM may include a broadcasting company logo, a caption, a date, and an hour. The logo image LIM may include the title of a TV show. For convenience of description, various types of image displayed at the fixed position with the specific grayscale for the specific time are referred to as the logo image LIM. The logo surrounding image LBI may be an image displayed around the logo image LIM or an image corresponding to a surrounding of the logo image LIM. The correcting image CIM may be an image having the luminance corrected by the corrected image generator CIG.

The non-correcting image NCIM may be an image displayed on a remaining part of the display area DA except for the correcting area CA. The non-correcting image NCIM may be an image having the luminance not corrected through the corrected image generator CIG.

According to an embodiment of the disclosure, the logo image LIM may have a grayscale higher than a grayscale of the logo surrounding image LBI. However, the disclosure is not limited thereto. Alternatively, for example, the logo image LIM may have the grayscale equal to the grayscale of the logo surrounding image LBI.

Referring to FIG. 5B, the correcting area CA includes a logo area LA for displaying the logo image LIM and a logo surrounding area LBA for displaying the logo surrounding image LBI. According to an embodiment of the disclosure, the logo surrounding image LBI includes a first logo surrounding image LBI1 and a second logo surrounding image LBI2, and the logo surrounding area LBA includes a first logo surrounding area LBA1 and a second logo surrounding area LBA2. According to an embodiment of the disclosure, the second logo surrounding area LBA2 may be interposed between the logo area LA and the first logo surrounding area LBA1. The second logo surrounding area LBA2 may be adjacent to the logo area LA.

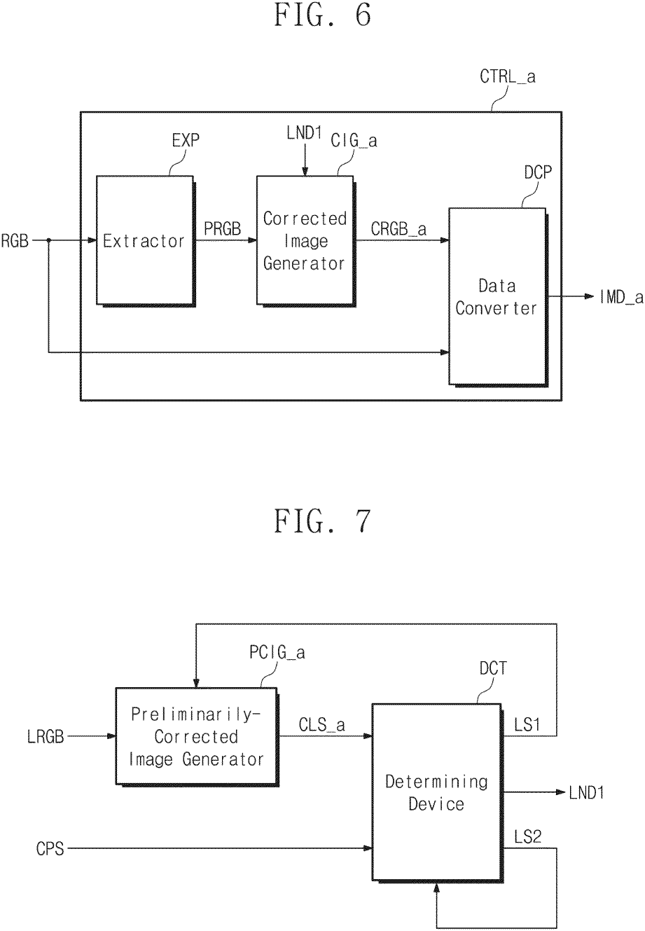

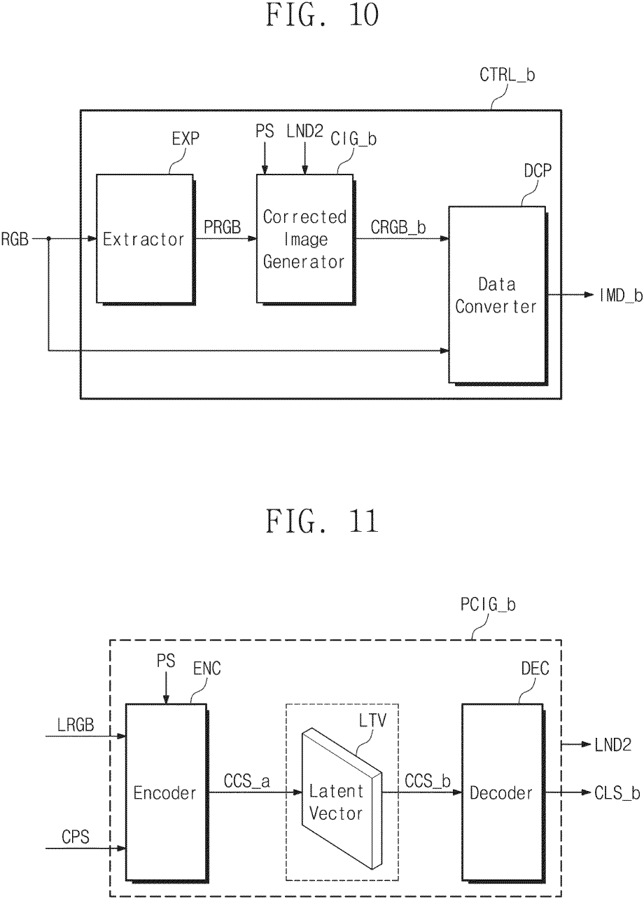

FIG. 6 is a block diagram illustrating the structure and the operation of a controller, when the correcting algorithm trained is a correcting algorithm for preventing an afterimage. FIG. 7 is a block diagram illustrating the process of training a correcting algorithm, according to an embodiment of the disclosure. Hereinafter, embodiments where the correcting algorithm trained in the machine learning scheme, which is included in corrected image generators CIG_a and CIG_b(see FIG. 10), is to (e.g., is used to or is performed to) correct the luminance of an image displayed on the correcting area CA to prevent an afterimage resulting from a pixel PX (see FIG. 3) deteriorated will be described.

Referring to FIGS. 5B and 6, in an embodiment, a controller CTRL_a includes an extractor EXP, a corrected image generator CIG_a, and the data converter DCP.

The extractor EXP may extract a partial image signal PRGB, which corresponds to the correcting area CA, from the image signal RGB corresponding to the display area DA (see FIG. 5A). According to an embodiment of the disclosure, the partial image signal PRGB may include a logo area signal for an image to be displayed on the logo area LA. The partial image signal PRGB may further include a first logo surrounding area signal for an image to be displayed on the first logo surrounding area LBA1 and a second logo surrounding area signal for an image to be displayed on the second logo surrounding area LBA2, in addition to the logo area signal. According to an embodiment of the disclosure, the extractor EXP may include an extracting program trained in a machine learning scheme or a deep learning scheme to detect the correcting area CA. In an embodiment, for example, the extractor EXP may extract the partial image signal PRGB from the image signal RGB by using the program trained through the deep learning scheme based on a convolutional neural network. The extractor EXP may extract the correcting area CA by analyzing the image IM displayed on the display panel DP for a preset time period. Alternatively, the correcting area CA may be extracted by analyzing frames of the image IM, which are repeated at a specific time point.

The corrected image generator CIG_a receives the partial image signal PRGB from the extractor EXP. The corrected image generator CIG_a includes a correcting algorithm trained in a machine learning scheme. The corrected image generator CIG_a corrects the partial image signal PRGB to a corrected image signal CRGB_a through the correcting algorithm. According to an embodiment of the disclosure, the correcting algorithm included in the corrected image generator CIG_a may be an algorithm trained based on a generative adversarial network (GAN) model. In such an embodiment, the corrected image generator CIG_a may receive first learning data LND1 including a weight of the correcting algorithm, which is produced in a process of training the correcting algorithm based on the GAN model. The corrected image generator CIG_a may generate the corrected image signal CRGB_a by correcting the partial image signal PRGB based on the correcting algorithm and the first learning data LND1.

FIG. 7 is a block diagram illustrating the process of training the correcting algorithm based on the GAN model. Referring to FIGS. 6 and 7, according to an embodiment of the disclosure, the GAN model may include a deep convolutional GAN (DGGAN) model, a bidirectional GAN (BiGAN) model, a cycle GAN model, a progressive GAN model, or a style GAN model. However, the disclosure is not limited thereto.

According to an embodiment of the disclosure, the GAN model includes a preliminarily-corrected image generator PCIG_a and a determining device DCT. According to an embodiment of the disclosure, a training image signal LRGB is applied to the preliminarily-corrected image generator PCIG_a. According to an embodiment of the disclosure, the training image signal LRGB may include the logo image LIM (see FIG. 5A), such as a broadcasting company logo, a caption, a date, and an hour, and the logo surrounding image LBI (see FIG. 5A).

The preliminarily-corrected image generator PCIG_a may generate a correction-training image signal CLS_a based on the training image signal LRGB. The correction-training image signal CLS_a generated from the preliminarily-corrected image generator PCIG_a may have first probability distribution.

The determining device DCT receives the comparing image signal CPS from the outside, and receives the correction-training image signal CLS_a from the preliminarily-corrected image generator PCIG_a. The comparing image signal CPS may have second probability distribution. The determining device DCT generates a determining signal based on the difference between the first probability distribution of the correction-training image signal CLS_a and the second probability distribution of the comparing image signal CPS.

According to an embodiment of the disclosure, the determining device DCT is to determine whether the comparing image signal CPS differs from the correction-training image signal CLS_a. Accordingly, when the determining device DCT has high performance, the probability, in which the two signals are determined to be mutually different signals based on the first probability distribution and the second probability distribution, is increased, so the determining signal may be increased. When the preliminarily-corrected image generator PCIG_a has high performance, the probability, in which the two signals are determined to be mutually different signals based on the first probability distribution and the second probability distribution, is decreased, so the determining signal may be decreased. The determining device DCT compares the determining signal with a preset reference value, and generates a first training signal LS1 or a second training signal LS2 based on the comparison result. The determining device DCT generates the first training signal LS1 when the determining signal is greater than the reference value, and generates the second training signal LS2 when the determining signal is less than the reference value. The first training signal LS1 is a signal for training the preliminarily-corrected image generator PCIG_a, and the second training signal LS2 is a signal for the determining device DCT to automatically learn. According to an embodiment of the disclosure, when the determining signal is the same as the reference value, the determining device DCT may not generate the first training signal LS1 and the second training signal LS2. According to an embodiment of the disclosure, when the determining signal is the same as the reference value, the training of the correcting algorithm based on the GAN model may be completed. The determining device DCT may generate first learning data LND1, when the determining signal is the same as a reference value.

According to an embodiment of the disclosure, the comparing image signal CPS may be an image signal generated by correcting the training image signal LRGB through a preset target algorithm. In such an embodiment, the determining device DCT generates the determining signal by comparing the correction-training image signal CLS_a with the comparing image signal CPS, and generates the first training signal LS1 and the second training signal LS2 by comparing the determining signal with the reference value. Accordingly, the correction-training image signal CLS_a, which is generated from the preliminarily-corrected image generator PCIG_a trained, may not be distinguished from the comparing image signal CPS. In such an embodiment, the correcting algorithm trained based on the GAN model may be an algorithm trained based on the target algorithm.

According to an embodiment of the disclosure, the corrected image generator CIG_a included in the controller CTRL_a may include a correcting algorithm trained through the process of FIG. 7. In such an embodiment, the corrected image generator CIG_a may receive first learning data LND1 including a weight of the correcting algorithm, which is produced in a process illustrated in FIG. 7. According to an embodiment of the disclosure, the weight of the correcting algorithm may be produced based on the change in value of the determining signal produced by the determining device DCT, depending on the type of an image included in the training image signal LRGB.

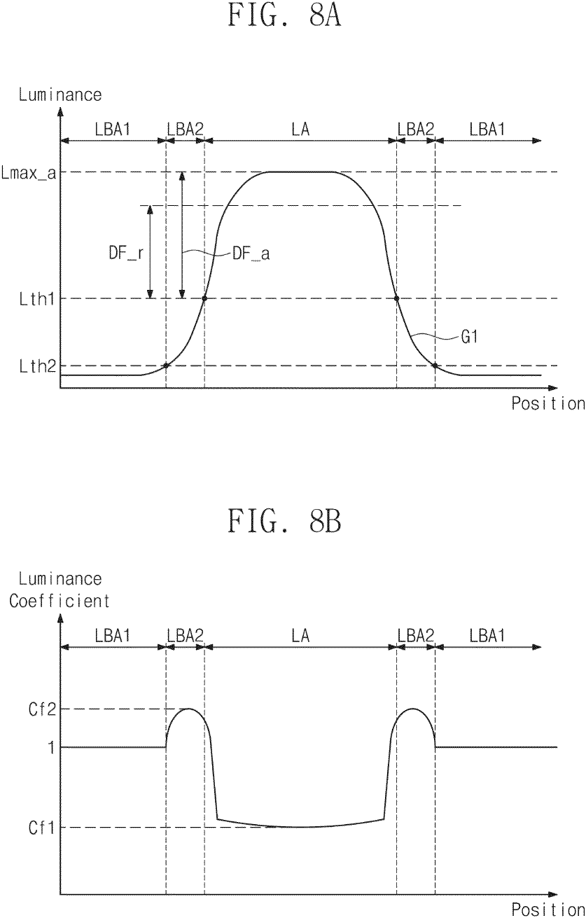

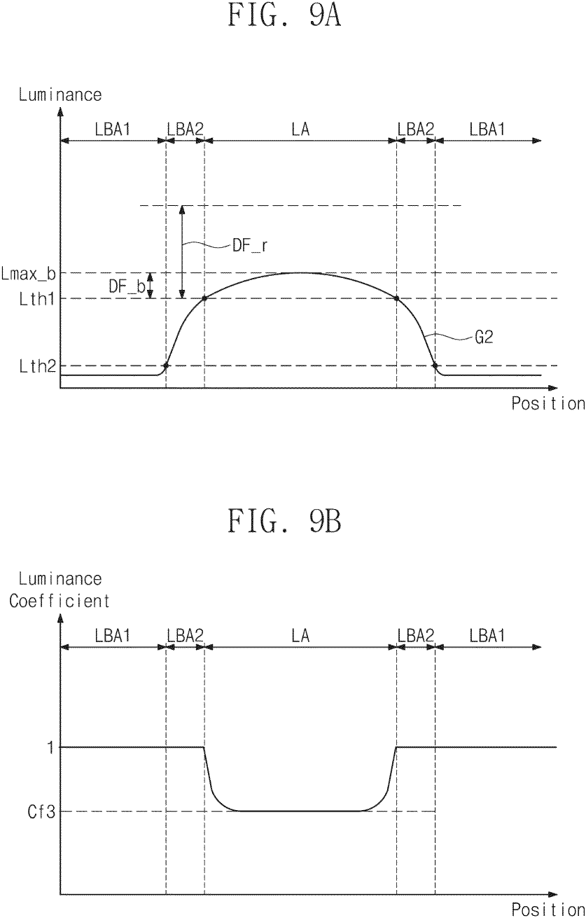

FIGS. 8A to 9B are graphs illustrating a correcting algorithm trained, according to an embodiment of the disclosure. FIGS. 8A to 9B are graphs for a portion of the correcting image CIM along line I-I′ of FIG. 5B, according to an embodiment of the disclosure.

Referring to FIGS. 6, 8A, and 8B, according to an embodiment of the disclosure, the corrected image generator CIG_a may perform color coordinate transformation to transform color information (red, green, blue) included in the partial image signal PRGB to data corresponding to a luminance component and data corresponding to a chrominance component. According to the disclosure, the corrected image generator CIG_a may classify the partial image signal PRGB into the logo area signal, the first logo surrounding area signal, and the second logo surrounding area signal, based on data, which corresponds to the luminance component, of data obtained through the color coordinate transformation. Hereinafter, embodiments where the correcting algorithm included in the corrected image generator CIG_a is to classify the partial image signal PRGB into the logo area signal, the first logo surrounding area signal, and the second logo surrounding area signal, based on the luminance will be described.

The correcting algorithm is to classify, as the logo area signal, a partial image signal corresponding to an image having luminance greater than a first luminance reference value Lth1, after setting the first luminance reference value Lth1 and a second luminance reference value Lth2 less than the first luminance reference value Lth1. The correcting algorithm is to classify, as the second logo surrounding area signal, a partial image signal corresponding to an image having luminance less than the first luminance reference value Lth1 and greater than the second luminance reference value Lth2. The correcting algorithm is to classify, as the first logo surrounding area signal, a partial image signal corresponding to an image having luminance less than the second luminance reference value Lth2. However, the disclosure is not limited thereto. In an embodiment, for example, the correcting algorithm may be to classify the partial image signal PRGB into the logo area signal, the first logo surrounding area signal, and the second logo surrounding area signal, based on a hue, a saturation, and a value(brightness), in addition to the luminance. In an embodiment, the correcting algorithm may be to classify, as the second logo surrounding area signal, a partial image signal corresponding to an image within a specific distance from an image displayed on the logo area LA.

According to an embodiment of the disclosure, the correcting algorithm may find a first maximum luminance Lmax_a, which indicates the highest luminance from the image corresponding to the logo area LA, and may calculate a first differential value DF_a between the first maximum luminance Lmax_a and the first luminance reference value Lth1. FIG. 8A illustrates a first graph G1 when the first differential value DF_a is greater than a preset reference differential value DF_r, according to an embodiment of the disclosure. In such an embodiment, the correcting algorithm may be to generate the corrected image signal CRGB_a to reduce the luminance of the logo area signal and to increase the luminance of the second logo surrounding area signal, when the first differential value DF_a is greater than the reference differential value DF_r, as the reference differential value DF_r is compared with the first differential value DF_a. According to an embodiment of the disclosure, the corrected image generator CIG_a may maintain the luminance of the first logo surrounding area signal uniform. According to an embodiment of the disclosure, the reference differential value DF_r is a luminance differential value to prevent an afterimage from being viewed by a user, as no substantial difference exist between the luminance of the image corresponding to the corrected logo area signal and the luminance of the image corresponding to the second logo surrounding area signal, even if the correcting algorithm is to perform correction to reduce only the luminance of the logo area signal.

The corrected image generator CIG_a generates a corrected logo area signal by multiplying the luminance of the logo area signal by a first luminance coefficient Cf1 less than ‘1’. The corrected image generator CIG_a generates the corrected surrounding area signal by multiplying the luminance of the second logo surrounding area signal by a second luminance coefficient Cf2 greater than ‘1’. According to an embodiment of the disclosure, the luminance of an image corresponding to the corrected logo area signal is lower than the luminance of the image corresponding to the logo area signal. According to an embodiment of the disclosure, the luminance of an image corresponding to the corrected surrounding area signal is higher than the luminance of the image corresponding to the second logo surrounding area signal. Accordingly, even if the first differential value DF_a is greater than the reference differential value DF_r, an afterimage due to the difference in luminance between the logo image LIM and the second logo surrounding image LBI2 may be prevented from being viewed by the user.

Referring to FIGS. 6, 9A, and 9B, the correcting algorithm included in the corrected image generator CIG_a is to classify the partial image signal PRGB into the logo area signal, the first logo surrounding area signal, and the second logo surrounding area signal, based on the first luminance reference value Lth1 and the second luminance reference value Lth2. Hereinafter, components and signals, which are the same as the components and signals described with reference to FIGS. 8A and 8B, will be assigned with the same reference numerals and any repetitive detailed description thereof will be omitted to avoid redundancy.

According to an embodiment of the disclosure, the correcting algorithm may be to find a second maximum luminance Lmax_b indicating the highest luminance of the image corresponding to the logo area LA, and to calculate the second differential value DF_b between the second maximum luminance Lmax_b and the first luminance reference value Lth1. FIG. 9A illustrates a second graph G2, when the second differential value DF_b is less than the preset reference differential value DF_r, according to an embodiment of the disclosure.

The correcting algorithm may be to generate the corrected image signal CRGB_a to reduce the luminance of the logo area signal, when the second differential value DF_b is less than the reference differential value DF_r. According to an embodiment of the disclosure, the corrected image generator CIG_a may maintain the luminance of the first logo surrounding area signal and the luminance of the second logo surrounding area signal uniform.

The corrected image generator CIG_a generates a corrected logo area signal by multiplying the luminance of the logo area signal by a third luminance coefficient Cf3 less than ‘1’. According to an embodiment of the disclosure, the luminance of an image corresponding to the corrected logo area signal is lower than the luminance of the image corresponding to the logo area signal. Since the second differential value DF_b is less than the reference differential value DF_r, even if the correction is performed to reduce only the luminance of the logo area signal, an afterimage due to the difference in luminance between the logo image LIM and the second logo surrounding image LBI2 may be prevented from being viewed by the user.

According to an embodiment of the disclosure, since the second maximum luminance Lmax_b is less than the first maximum luminance Lmax_a, the third luminance coefficient Cf3 to reduce the luminance of the logo area signal may be greater than the first luminance coefficient Cf1. According to an embodiment of the disclosure, the corrected image generator CIG_a may generate the corrected image signal CRGB_a, based on a correcting algorithm, and the weight of a correcting algorithm included in the first learning data LND1. The weight of the correcting algorithm is reflected with the difference in value between determining signals generated depending on the type of an image included in the training image signal LRGB (see FIG. 7). Accordingly, the corrected image generator CIG_a may generate and provide the correcting image CIM, which may be smoothly viewed by a user, regardless of the type of the image included in the partial image signal PRGB.

However, the disclosure is not limited thereto. According to an embodiment of the disclosure, through the trained correcting algorithm, the correction may be performed to reduce both the luminance of the logo area signal and the luminance of the second logo surrounding area signal, even if the second differential value DF_b is less than the reference differential value DF_r. In this case, the degree to which the luminance of the logo area signal is lowered and the degree to which the luminance of the second logo surrounding area signal is lowered may be different from each other.

FIG. 10 is a block diagram illustrating the structure and the operation of a controller, when the trained correcting algorithm is to prevent an afterimage. FIG. 11 is a block diagram illustrating the process of training a correcting algorithm, according to an embodiment of the disclosure. Hereinafter, components and signals, which are the same as the components and signals described with reference to FIG. 6, and FIG. 7, will be assigned with the same reference numerals and any repetitive detailed description thereof will be omitted to avoid redundancy.

According to an embodiment of the disclosure, a corrected image generator CIG_b included in a controller CTRL_b includes a correcting algorithm trained based on the VAE model. The corrected image generator CIG_b corrects the partial image signal PRGB to a corrected image signal CRGB_b through the correcting algorithm. In an embodiment, the corrected image generator CIG_b may receive second learning data LND2 including a weight of the correcting algorithm, which is produced in a process of training the correcting algorithm based on the VAE model. The corrected image generator CIG_b may generate the corrected image signal CRGB_b by correcting the partial image signal PRGB based on the correcting algorithm and the second learning data LND2. According to an embodiment of the disclosure, the corrected image generator CIG_b may further receive a parameter signal PS. According to an embodiment of the disclosure, the parameter signal PS may be a signal including a parameter for a feature, which is to be corrected through the corrected image generator CIG_b, of the partial image signal PRGB. The corrected image generator CIG_b may generate the corrected image signal CRGB_b based on the correcting algorithm, the second learning data LND2, and the parameter signal PS. When the corrected image generator CIG_b generates the corrected image signal CRGB_b, based on the parameter signal PS, the corrected image generator CIG_b may generate the corrected image signal CRGB_b which is obtained by correcting only the feature, which is to be corrected through the corrected image generator CIG_b, of the partial image signal PRGB.

FIG. 11 is a block diagram illustrating the procedure of training the correcting algorithm based on the VAE model. According to an embodiment of the disclosure, the VAE model may be a conditional VAE model, or an adversarial autoencoder (AAE) model, and the disclosure is not limited thereto.

According to an embodiment of the disclosure, the VAE model includes a preliminarily-corrected image generator PCIG_b. The preliminarily-corrected image generator PCIG_b may include an encoder ENC, a latent vector LTV, and a decoder DEC.

The encoder ENC receives the training image signal LRGB and the comparing image signal CPS. The encoder ENC compresses the training image signal LRGB, which is received in the encoder ENC, to generate a correction-encoded signal CSS_a in a lower dimension, based on the training image signal LRGB in the higher dimension. According to an embodiment of the disclosure, the encoder ENC may generate the correction-encoded signal CSS_a by encoding the training image signal LRGB.

According to an embodiment of the disclosure, the correction-encoded signal CSS_a encoded through the encoder ENC may constitute the latent vector LTV.

The decoder DEC may perform sampling for the correction-encoded signal CSS_a, based on the latent vector LTV. The decoder DEC generates a correction-training image signal CLS_b, by decoding a correction-encoded signal CCS_b obtained after the sampling.

According to an embodiment of the disclosure, the encoder ENC may encode the training image signal LRGB, based on the comparing image signal CPS. The comparing image signal CPS may be an image signal generated by correcting the training image signal LRGB through a preset target algorithm. When the encoder ENC encodes the training image signal LRGB, based on the comparing image signal CPS, at least one of the encoder ENC and the decoder DEC may be trained based on the VAE model, such that the probability distribution of the correction-training image signal CLS_b is similar to the probability distribution of the comparing image signal CPS. According to an embodiment of the disclosure, when the encoder ENC encodes the training image signal LRGB, based on the comparing image signal CPS, the configuration of the latent vector LTV may be changed such that the decoder DEC generates the correction-training image signal CLS_b having the probability distribution similar to the probability distribution of the comparing image signal CPS.

According to an embodiment of the disclosure, the encoder ENC may further receive a parameter signal PS. The encoder ENC may encode the training image signal LRGB, based on the parameter signal PS. The parameter signal PS may include a parameter for a feature indicating the difference between the training image signal LRGB and the comparing image signal CPS. The decoder DEC may generate the correction-training image signal CLS_b having the probability distribution similar to the probability distribution of the comparing image signal CPS by decoding the correction-encoded signal CCS_b sampled based on the parameter included in the parameter signal PS.

According to an embodiment of the disclosure, when the difference between the probability distribution of the comparing image signal CPS and the probability distribution of the correction-training image signal CLS_b reaches a value within a preset value range, the training of the correcting algorithm may be finished in the VAE model. The preliminarily-corrected image generator PCIG_b may further generate the second learning data LND2, when the difference between the probability distribution of the comparing image signal CPS and the probability distribution of the correction-training image signal CLS_b reaches a value within the preset value range. Based on the VAE model, at least one of the encoder ENC and the decoder DEC may be trained by comparing the comparing image signal CPS with the correction-training image signal CLS_b. In such an embodiment, the correcting algorithm trained based on the VAE model may be an algorithm trained based on the target algorithm.

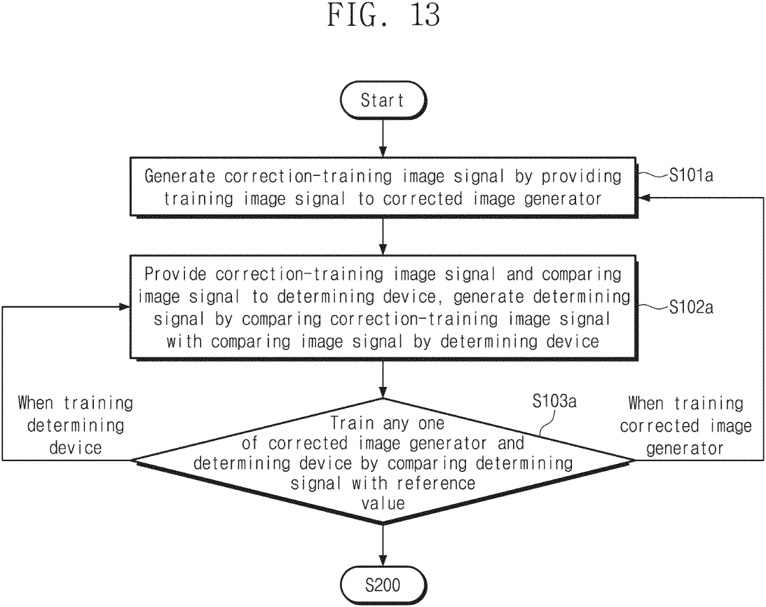

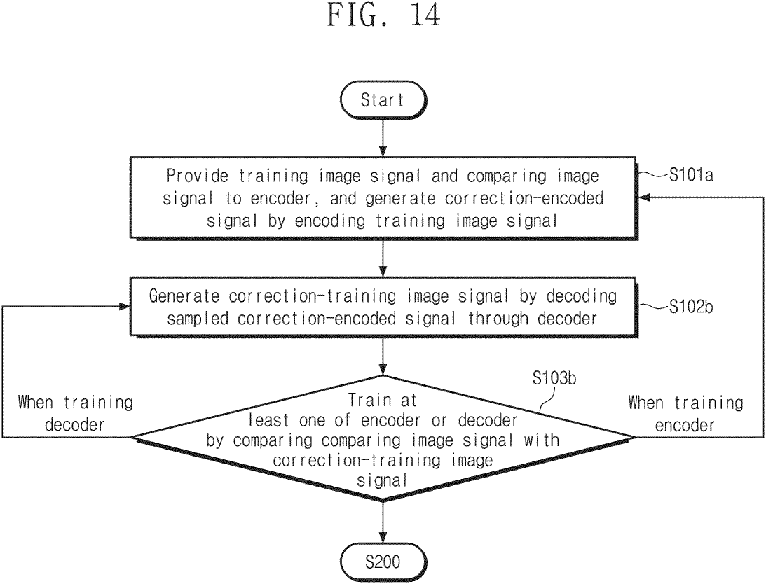

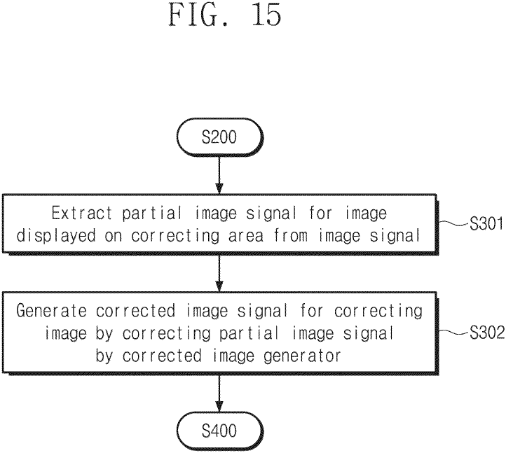

FIG. 12 is a flowchart illustrating a method for driving a display device, according to an embodiment of the disclosure. FIGS. 13 and 14 are flowcharts illustrating a method for training a correcting algorithm in a machine learning scheme, according to an embodiment of the disclosure. FIG. 15 is a flowchart illustrating a method for generating a corrected image signal to prevent an afterimage through a correcting algorithm trained, according to an embodiment of the disclosure.

Referring to FIGS. 6, 12, and 15, the method for correcting the image IM displayed on the display panel DP (see FIG. 2) through the correcting algorithm trained in the machine learning scheme includes receiving an image signal from an outside (S200). The controller CTRL_a receives the image signal RGB from the outside.

Thereafter, the corrected image signal CRGB_a is generated by correcting the image signal RGB through the corrected image generator CIG_a including the correcting algorithm trained in the machine learning scheme (S300). According to an embodiment of the disclosure, the generating of the corrected image signal CRGB_a includes extracting the partial image signal PRGB corresponding to the correcting area CA (see FIG. 5A) from the image signal RGB by the extractor EXP included in the controller CTRL_a (S301), and generating the corrected image signal CRGB_a by correcting the partial image signal PRGB by the corrected image generator CIG_a (S302). According to an embodiment of the disclosure, in the generating of the corrected image signal CRGB_a (S302), the corrected image generator CIG_a may generate the corrected image signal CRGB_a in a way such that the luminance of the logo area signal is decreased and the luminance of the second logo surrounding area signal is increased.

The controller CTRL_a may display the image IM (see FIG. 5A) on the display panel DP, based on the corrected image signal CRGB_a generated by the corrected image generator CIG_a (S400). According to an embodiment of the disclosure, the displaying (S400) of the image IM on the display panel DP may further include generating, by the data converter DCP, which is included in the controller (CTRL in FIG. 4, CTRL_a in FIG. 6 or CTRL_b in FIG. 10), image data (IMD in FIG. 4, IMD_a in FIG. 6 or IMD_b in FIG. 10) based on corrected image signal (CRGB in FIG. 4, CRGB_a in FIG. 6 or CRGB_b in FIG. 10) and the image signal RGB, and generating, by the source driver SD (see FIG. 3), the data signal DS based on the image data (IMD in FIG. 4, IMD_a in FIG. 6 or IMD_b in FIG. 10).

According to an embodiment of the disclosure, as shown in FIG. 12, the method for correcting the image IM, which is displayed on the display panel DP, through the correcting algorithm trained in the machine learning scheme may further include training the correcting algorithm in the machine learning scheme (S100).

Referring to FIGS. 7 and 13, in an embodiment where the correcting algorithm is trained based on the GAN model, the method includes generating the correction-training image signal CLS_a by providing the training image signal LRGB to the corrected image generator CIG_a (S101a) and providing the correction-training image signal CLS_a and the comparing image signal CPS to the determining device DCT and generating a determining signal, by the determining device DCT, by comparing the correction-training image signal CLS_a with the comparing image signal CPS (S102a). Thereafter, the method includes operation to train the corrected image generator CIG_a or the determining device DCT by comparing the determining signal with the preset reference value (S103a).

Referring to FIGS. 11 and 14, in an embodiment where the correcting algorithm is trained based on the VAE model, the method includes providing the training image signal LRGB and the comparing image signal CPS to the encoder ENC, and generating a correction-encoded signal CCS_a by encoding the training image signal LRGB (S101b) and generating the correction-training image signal CLS_b by decoding a correction-encoded signal CCS_b, which is sampled, through the decoder DEC (S102b). Thereafter, at least one of the encoder ENC and the decoder DEC is trained by comparing the comparing image signal CPS with the correction-training image signal CLS_b (S103b).

According to embodiments of the disclosure, the image displayed on the display panel may be corrected through the correcting algorithm trained in the machine learning scheme. The display quality may be prevented from being degraded due to an unpredicted correction error caused when correcting the image through the training process based on the machine learning scheme. In such embodiments, the correcting algorithm for correcting a logo image may be trained in the machine learning scheme to prevent the display panel from being deteriorated. The logo image may be corrected through the correcting algorithm, thereby preventing the display panel from being deteriorated and providing the image having the improved display quality to the user.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel which displays an image; and
a panel driving block which receives an image signal from an outside, and drives the display panel,
wherein the panel driving block includes:
a corrected image generator including a correcting algorithm trained in a machine learning scheme, wherein the corrected image generator corrects the image signal to a corrected image signal through the correcting algorithm.

2. The display device of claim 1, wherein the correcting algorithm is trained based on a generative adversarial network model.

3. The display device of claim 2, wherein the corrected image generator:
receives first learning data including a weight of the correcting algorithm, which is produced in a process of training the correcting algorithm based on the generative adversarial network model; and
generates the corrected image signal by correcting the image signal based on the correcting algorithm and the first learning data.

4. The display device of claim 1, wherein the correcting algorithm is trained based on a variational auto encoder model.

5. The display device of claim 4, wherein the corrected image generator:
receives second learning data including a weight of the correcting algorithm, which is produced in a process of training the correcting algorithm based on the variational auto encoder model; and
generates the corrected image signal by correcting the image signal, based on the correcting algorithm and the second learning data.

6. The display device of claim 1, wherein the display panel includes:
a correcting area of the image, in which a correcting image is displayed, wherein the correcting image includes a logo image and a logo surrounding image corresponding to a surrounding of the logo image, and
wherein the corrected image generator corrects a partial image signal, which corresponds to the correcting area, of the image signal to the corrected image signal.

7. The display device of claim 6, wherein the correcting area includes:
a logo area in which the logo image is displayed; and
a logo surrounding area in which the logo surrounding image is displayed,
wherein the partial image signal includes:
a logo area signal for the logo image, and
wherein the corrected image generator generates the corrected image signal by correcting the logo area signal.

8. The display device of claim 7, wherein the logo surrounding image includes:
a first logo surrounding image; and
a second logo surrounding image,
wherein the logo surrounding area includes:
a first logo surrounding area in which the first logo surrounding image is displayed; and
a second logo surrounding area in which the second logo surrounding image is displayed, wherein the second logo surrounding area is interposed between the logo area and the first logo surrounding area,
wherein the partial image signal further includes a surrounding area signal for the second logo surrounding image, and
wherein the corrected image generator generates the corrected image signal by correcting the logo area signal and the surrounding area signal.

9. The display device of claim 8, wherein the corrected image generator:
generates the corrected image signal in a way such that luminance of the logo area signal is decreased and luminance of the surrounding area signal is increased.

10. The display device of claim 6, wherein the panel driving block further includes:
an extractor which extracts the partial image signal from the image signal, and
wherein the corrected image generator:
receives the partial image signal from the extractor; and
generates the corrected image signal by correcting the partial image signal.

11. The display device of claim 10, wherein the panel driving block includes:
a controller which generates image data based on the image signal; and
a source driver which receives the image data from the controller, generates a data signal based on the image data and transmits the data signal to the display panel, and
wherein the extractor and the corrected image generator are included in the controller.

12. The display device of claim 11, wherein the controller further includes:
a data converter which receives the image signal and the corrected image signal, and generates the image data, based on the image signal and the corrected image signal.

13. A method for driving a display device, the method comprising:
receiving an image signal from an outside;
generating a corrected image signal by correcting the image signal by a corrected image generator of the display device, wherein the corrected image generator includes a correcting algorithm trained in a machine learning scheme; and
displaying an image on a display panel, based on the corrected image signal.

14. The method of claim 13, further comprising:
training the correcting algorithm in the machine learning scheme.

15. The method of claim 14, wherein the correcting algorithm is trained based on a generative adversarial network model.

16. The method of claim 15, wherein the training the correcting algorithm includes:
generating a correction-training image signal by applying a training image signal to a preliminarily-corrected image generator;
applying the correction-training image signal and a comparing image signal to a determining device;
allowing the determining device to generate a determining signal by comparing the correction-training image signal with the comparing image signal; and
training at least one selected from the preliminarily-corrected image generator and the determining device, by comparing the determining signal with a reference value.

17. The method of claim 14, wherein the correcting algorithm is trained based on a variational auto encoder model.

18. The method of claim 17, wherein
wherein the training the correcting algorithm includes:
applying a training image signal and a comparing image signal to an encoder of a preliminarily-corrected image generator;
generating a correction-encoded signal by encoding the training image signal;
generating a correction-training image signal by decoding a sampled correction-encoded signal through a decoder of the preliminarily-corrected image generator; and
training at least one selected from the encoder and the decoder, by comparing the comparing image signal with the correction-training image signal.

19. The method of claim 13, wherein the display panel includes:
a correcting area, in which a correcting image of the image is displayed, wherein the correcting image includes a logo image and a logo surrounding image corresponding to a surrounding of the logo image,
wherein the generating the corrected image signal includes:
extracting a partial image signal, which corresponds to the correcting area, from the image signal; and
generating, by the corrected image generator, the corrected image signal by correcting the partial image signal.

20. The method of claim 19, wherein the logo surrounding image includes:
a first logo surrounding image and a second logo surrounding image,
wherein the correcting area includes:
a logo area in which the logo image is displayed, a first logo surrounding area in which the first logo surrounding image is displayed, and a second logo surrounding area in which the second logo surrounding image is displayed, wherein the second logo surrounding area is interposed between the logo area and the first logo surrounding area,
wherein the partial image signal includes:
a logo area signal for the logo image and a surrounding area signal for the second logo surrounding image, and
wherein the generating the corrected image signal includes:
generating, by the corrected image generator, the corrected image signal in a way such that luminance of the logo area signal is decreased and luminance of the surrounding area signal is increased.
